(19) United States
(12) Patent Application Publication
(10) Pub. No.: US 2025/0390992 A1
(43) Pub. Date: Dec. 25, 2025

(54) IMAGE PROCESSING METHOD AND APPARATUS

(71) Applicant: Beijing Zitiao Network Technology Co., Ltd., Beijing (CN)

(72) Inventor: Yang Bai, Beijing (CN)

(21) Appl. No.: 19/243,181

(22) Filed: Jun. 19, 2025

(30) Foreign Application Priority Data
Jun. 19, 2024 (CN) 202410797252.5

(51) Int. Cl. G06T 5/70

(52) U.S. Cl. CPC G06T 5/70; G06T 2200/24; G06T 2207/10024

(57) ABSTRACT

Embodiments of the present disclosure provide an image processing method and apparatus and relate to image processing technologies. The method comprises: displaying a blur parameter setting interface; determining a weight attenuation coefficient and a radial blur center of an initial image according to a user's operation in the blur parameter setting interface; performing radial blur sampling on a first pixel point according to the radial blur center, and acquiring a color value of at least one sampling point, the first pixel point being any pixel point; acquiring a weight coefficient of each sampling point according to an initial weight coefficient and the weight attenuation coefficient; acquiring a radial blur color value of the first pixel point according to the weight coefficient of each sampling point and the color value of each sampling point; assigning the radial blur color value of the first pixel point to the first pixel point.

### CROSS-REFERENCE TO RELATED APPLICATION(S)

This application claims priority to Chinese Application No. 202410797252.5 filed Jun. 19, 2024, the disclosure of which is incorporated herein by reference in its entirety.

### FIELD

The present disclosure relates to the field of image processing technologies, and particularly, to an image processing method and apparatus.

### BACKGROUND

A light-radiating effect of an image is a visual presentation effect, specifically, an effect generated by light rays or a beam of light radiated outward from a specific center point of the image. The light-radiating effect of the image has been widely used in fields such as poster design, sign design, user interface design, game development and special effects of movies and television programs as having functions such as making the image have a definite central point and adding vitality and motion to the image.

### SUMMARY

Embodiments of the present disclosure provide an image processing method and apparatus for extending the adjustability of radial blur processing.

In order to achieve the object, the embodiments of the present disclosure provide the following technical solutions:

In a first aspect, an embodiment of the present disclosure provides an image processing method, comprising:
displaying a blur parameter setting interface;
determining a weight attenuation coefficient and a radial blur center of an initial image according to a user's operation in the blur parameter setting interface;
performing radial blur sampling on a first pixel point according to the radial blur center, and acquiring a color value of at least one sampling point, the first pixel point being any pixel point of the initial image;
acquiring a weight coefficient of each sampling point according to an initial weight coefficient and the weight attenuation coefficient;
acquiring a radial blur color value of the first pixel point according to the weight coefficient of each sampling point and the color value of each sampling point;
assigning the radial blur color value of the first pixel point to the first pixel point.

As an optional embodiment of the embodiment of the present disclosure, the acquiring a weight coefficient of each sampling point according to an initial weight coefficient and the weight attenuation coefficient comprises:
calculating the weight coefficient of each sampling point by the following equation:

$${w}_{i} = {w}_{0} * {D}^{i - 1}$$

where Wᵢ is the weight coefficient of the i^{th} sampling point, w₀ is the initial weight coefficient, and D is the weight attenuation coefficient.

As an optional implementation of an embodiment of the present disclosure, the acquiring a radial blur color value of the first pixel point according to the weight coefficient of each sampling point and the color value of each sampling point comprises:
respectively calculating a product of the weight coefficient and the color value of each sampling point, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a radial blur color value of the first pixel point.

As an optional implementation of an embodiment of the present disclosure, the method further comprises: determining a non-linear adjustment parameter according to the user's operation in the blur parameter setting interface;
the acquiring a radial blur color value of the first pixel point according to the weight coefficient of each sampling point and the color value of each sampling point comprises:
respectively calculating a product of the weight coefficient and the color value of each sampling point, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a first color value;
determining a power of the non-linear adjustment parameter of the first color value as a radial blur color value of the first pixel point.

As an optional implementation of an embodiment of the present disclosure, the method further comprises: determining a non-linear adjustment parameter and a scale parameter according to the user's operation in the blur parameter setting interface;
the acquiring a radial blur color value of the first pixel point according to the weight coefficient of each sampling point and the color value of each sampling point comprises:
respectively calculating a product of the weight coefficient and the color value of each sampling point, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a first color value;
calculating a power of the non-linear adjustment parameter of the first color value to obtain a second color value;
determining a product of the second color value and the scale parameter as a radial blur color value of the first pixel point.

As an optional implementation of an embodiment of the present disclosure, the method further comprises: determining a non-linear adjustment parameter, a scale parameter and an offset parameter according to the user's operation in the blur parameter setting interface;
the acquiring a radial blur color value of the first pixel point according to the weight coefficient of each sampling point and the color value of each sampling point comprises:
respectively calculating a product of the weight coefficient and the color value of each sampling point, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a first color value;
calculating a power of the non-linear adjustment parameter of the first color value to obtain a second color value;
calculating a product of the second color value and the scale parameter to obtain a third color value;
determining a sum of the third color value and the offset parameter as a radial blur color value of the first pixel point.

As an optional implementation of an embodiment of the present disclosure, the method further comprises: determining a scale parameter according to the user's operation in the blur parameter setting interface;
the acquiring a radial blur color value of the first pixel point according to the weight coefficient of each sampling point and the color value of each sampling point comprises:
respectively calculating a product of the weight coefficient and the color value of each sampling point, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a first color value;
determining a product of the first color value and the scale parameter as a radial blur color value of the first pixel point.

As an optional implementation of an embodiment of the present disclosure, the method further comprises:
acquiring a radial blur image corresponding to the initial image, at least one pixel point in the radial blur image corresponding to the initial image being assigned a corresponding radial blur color value;
superimposing and fusing the radial blur image corresponding to the initial image and the initial image to acquire a light-radiating effect image corresponding to the initial image.

In a second aspect, an embodiment of the present disclosure provides an image processing apparatus, comprising:
a display unit for displaying a blur parameter setting interface;
a determination unit for determining a weight attenuation coefficient and a radial blur center of an initial image according to a user's operation in the blur parameter setting interface;
a sampling unit for performing radial blur sampling on a first pixel point according to the radial blur center, and acquiring a color value of at least one sampling point, the first pixel point being any pixel point of the initial image;
a processing unit for acquiring a weight coefficient of each sampling point according to an initial weight coefficient and the weight attenuation coefficient;
a blurring unit for acquiring a radial blur color value of the first pixel point according to the weight coefficient of each sampling point and the color value of each sampling point;
a generation unit for assigning the radial blur color value of the first pixel point to the first pixel point.

As an optional embodiment of the embodiment of the present disclosure, the processing unit is specifically used for calculating the weight coefficient of each sampling point by the following equation:

$${w}_{i} = {w}_{0} * {D}^{i - 1}$$

where wᵢ is the weight coefficient of the i^{th} sampling point, w₀ is the initial weight coefficient, and D is the weight attenuation coefficient.

As an optional implementation of an embodiment of the present disclosure, the blurring unit is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a radial blur color value of the first pixel point.

As an optional implementation of an embodiment of the present disclosure, the determination unit is further used for determining a non-linear adjustment parameter according to the user's operation in the blur parameter setting interface;
the blurring unit is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a first color value; determining a power of the non-linear adjustment parameter of the first color value as a radial blur color value of the first pixel point.

As an optional implementation of an embodiment of the present disclosure, the determination unit is further used for determining a non-linear adjustment parameter and a scale parameter according to the user's operation in the blur parameter setting interface;
the blurring unit is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a first color value; calculating a power of the non-linear adjustment parameter of the first color value to obtain a second color value; determining a product of the second color value and the scale parameter as a radial blur color value of the first pixel point.

As an optional implementation of an embodiment of the present disclosure, the determination unit is further used for determining a non-linear adjustment parameter, a scale parameter and an offset parameter according to the user's operation in the blur parameter setting interface;
the blurring unit is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a first color value; calculating a power of the non-linear adjustment parameter of the first color value to obtain a second color value; calculating a product of the second color value and the scale parameter to obtain a third color value; determining a sum of the third color value and the offset parameter as a radial blur color value of the first pixel point.

As an optional implementation of an embodiment of the present disclosure, the determination unit is further used for determining a scale parameter according to the user's operation in the blur parameter setting interface;
the blurring unit is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a first color value; determining a product of the first color value and the scale parameter as a radial blur color value of the first pixel point.

As an optional implementation of an embodiment of the present disclosure, the generation unit is further used for acquiring a radial blur image corresponding to the initial image, at least one pixel point in the radial blur image corresponding to the initial image being assigned a corresponding radial blur color value; superimposing and fusing the radial blur image corresponding to the initial image and the initial image to acquire a light-radiating effect image corresponding to the initial image.

In a third aspect, an embodiment of the present disclosure provides an electronic device, comprising: a memory and a processor, the memory being used for storing a computer program, and the processor being used for causing the electronic device to implement the image processing method according to any of the above implementations upon executing the computer program.

In a fourth aspect, an embodiment of the present disclosure provides a computer-readable storage medium having stored thereon a computer program which, when executed by a processing device, causes the computing device to implement the image processing method according to any of the above implementations.

In a fifth aspect, an embodiment of the present disclosure provides a computer program product which, when run on a computer, causes the computer to implement the image processing method according to any of the above implementations.

### BRIEF DESCRIPTION OF THE DRAWINGS

The drawings here, which are incorporated in and constitute a part of the description, illustrate embodiments complying with the present disclosure and, together with the description, serve to illustrate the principles of the present disclosure.

In order to illustrate technical solutions in embodiments of the present disclosure or the prior art more clearly, figures to be used in the depictions of the embodiments or prior art will be introduced briefly below; it be obvious for those skilled in the art to obtain other figures according to these figures without making any inventive efforts.

FIG. 1 illustrates a flow chart showing steps of an image processing method according to an embodiment of the present disclosure;

FIG. 2 illustrates a first schematic diagram of a blur parameter setting interface according to an embodiment of the present disclosure;

FIG. 3 illustrates a second schematic diagram of a blur parameter setting interface according to an embodiment of the present disclosure;

FIG. 4 illustrates a third schematic diagram of a blur parameter setting interface according to an embodiment of the present disclosure;

FIG. 5 illustrates a fourth schematic diagram of a blur parameter setting interface according to an embodiment of the present disclosure;

FIG. 6 illustrates a schematic diagram of an image processing apparatus according to an embodiment of the present disclosure;

FIG. 7 illustrates a schematic diagram showing hardware of an electronic device according to an embodiment of the present disclosure.

### DETAILED DESCRIPTION OF EMBODIMENTS

Solutions of the present disclosure will be further described to enable clearer understanding of the above objectives, features and advantages of the present disclosure. It needs to be appreciated that embodiments of the present disclosure and features in the embodiments may be combined with one another in the absence of conflicts.

In the following description, a lot of specific details are illustrated to provide a thorough understanding of the present disclosure. However, the present disclosure may be also implemented otherwise than as specifically described herein. The embodiments in the description are only part of embodiments of the present disclosure other than all embodiments.

In the embodiments of the present disclosure, the words “exemplary” or “for example” are used to mean serving as an example, instance, or illustration. Any embodiment or design solution described herein as “exemplary” or “for example” should not be construed as being preferable or advantageous over other embodiments or designs. Rather, invoking the words such as “exemplary” or “such as” is intended to present relevant concepts in a specific manner. Further, in the depictions of the embodiments of the present disclosure, the meaning of “a plurality” means two or more unless otherwise specified.

A subject for implementing an image processing method according to embodiments of the present disclosure may be an image processing apparatus, and the image processing apparatus includes but is not limited to a terminal device such as a mobile phone, a tablet computer, a notebook computer, an Ultra-Mobile Personal Computer (UMPC), a netbook, a Personal Digital Assistant (PDA), a smart watch, a smart bracelet, etc.

Usually, the light-radiating effect of the image is achieved by performing a radial blur process on the image. However, at present, the adjustability of radial blurring is very weak, which makes it difficult to meet demands of an editing scenario for flexible adjustment of the light-radiating effect.

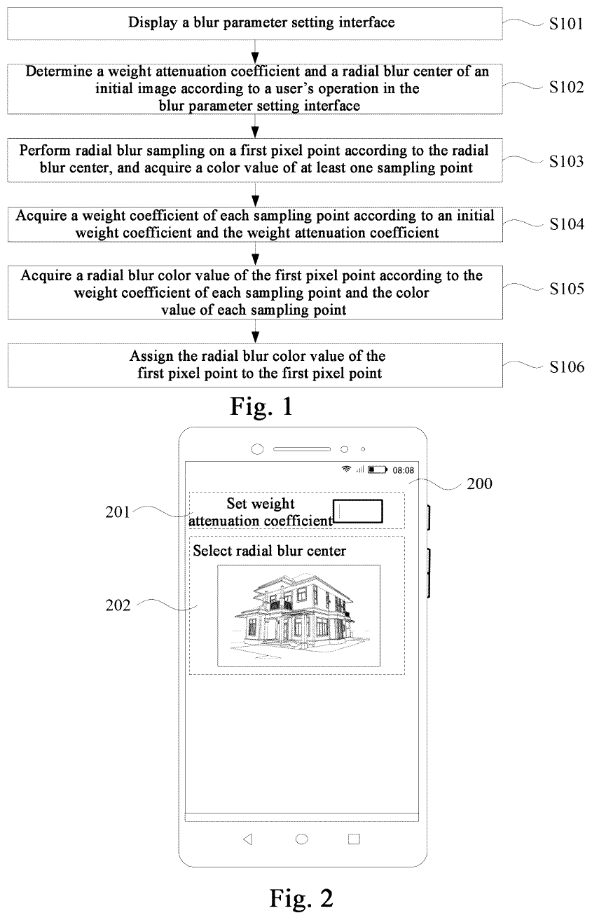

An embodiment of the present disclosure provides an image processing method. Referring to FIG. 1, the image processing method comprises the following steps:
S101: displaying a blur parameter setting interface.

The blur parameter setting interface in the embodiments of the present disclosure

refers to an interface provided by an image processing apparatus for setting or adjusting blur parameters. The blur parameter setting interface may comprise a control for adjusting at least one of a weight attenuation coefficient, a radial blur center, a blur radius, a non-linear adjustment parameter, a scale parameter, and an offset parameter.

Exemplarily, as shown in FIG. 2, a blur parameter setting interface 200 in FIG. 2 comprises: a first control 201 for setting the weight attenuation coefficient and a second control 202 for selecting the radial blur center. A user may operate on the first control 201 to set the weight attenuation coefficient and on the second control 202 to select the radial blur center.
S102: determining the weight attenuation coefficient and the radial blur center of an initial image according to the user's operation in the blur parameter setting interface.

In the embodiment of the present disclosure, the weight attenuation coefficient refers to a ratio of the weight coefficient of a sampling point next to a current sampling point to the weight coefficient of the current sampling point, and the radial blurring center refers to a central position of the blurring effect after performing the radial blur process on the image.

In some embodiments, the blur parameter setting interface comprises a weight attenuation coefficient input box for inputting the weight attenuation coefficient, and the determining the weight attenuation coefficient according to the user's operation in the blur parameter setting interface comprises: receiving the weight attenuation coefficient input by the user in the weight attenuation coefficient input box.

In some implementations, the blur parameter setting interface comprises a preview image of the initial image, and the determining the radial blur center of an initial image according to the user's operation in the blur parameter setting interface comprises: receiving a click operation input by the user on the preview image of the initial image, and determining a click position of the received click operation as the radial blur center of the initial image.
S103: performing radial blur sampling on a first pixel point according to the radial blur center, and acquiring a color value of at least one sampling point.

The first pixel point is any pixel point of the initial image.

In some embodiments, the performing radial blur sampling on a first pixel point according to the radial blur center comprises: determining a line connecting the radial blur center with the first pixel point, and performing sampling on the line connecting the radial blur center with the first pixel point.

In some embodiments, a sampling step size may be determined according to a length of the line connecting the radial blur center with the first pixel point and a preset number of sampling points, and sampling is performed along the line connecting the radial blur center with the first pixel point, starting from the first pixel point or the radial blur center according to the sampling step size, thereby determining the at least one sampling point, and acquiring a color value of the at least one sampling point.
S104: obtaining a weight coefficient of each sampling point according to the initial weight coefficient and the weight attenuation coefficient.

In some embodiments, the obtaining a weight coefficient of each sampling point according to the initial weight coefficient and the weight attenuation coefficient comprises:
calculate the weight coefficient of each sampling point according to the following equation:

$${w}_{i} = {w}_{0} * {D}^{i - 1}$$

where wᵢ is the weight coefficient of the i^{th} sampling point, w₀ is the initial weight coefficient, and D is the weight attenuation coefficient.

Exemplarily, when the initial weight coefficient is 1 and the weight attenuation coefficient is 0.98, the weight coefficient of the third sampling point is: 98².
S105: acquiring a radial blur color value of the first pixel point according to the weight coefficient of each sampling point and the color value of each sampling point.

In some embodiments, the acquiring a radial blur color value of the first pixel point according to the weight coefficient of each sampling point and the color value of each sampling point comprises the following step a through step d:
step a: respectively calculating a product of the weight coefficient and the color value of each sampling point, and acquiring weight color values of the sampling points;

If the weight coefficient of the i^{th} sampling point is represented as Wᵢ, the color value of the i^{th} sampling point is represented as Iᵢ, and the weight color value of the i^{th} sampling point is represented as Iᵢ^{w}, then:

$${I}_{i}^{w} = {w}_{i} * {I}_{i} = {w}_{0} * {D}^{i - 1} * {I}_{i}$$

step b: summing the weight color values of all sampling points to obtain a total color value.

If the total color value is represented as I^{A}, then:

$${I}^{A} = {\sum }_{i = 1}^{N} {I}_{i}^{w} = {\sum }_{i = 1}^{N} {w}_{i} * {I}_{i} = {\sum }_{i = 1}^{N} {w}_{0} * {D}^{i - 1} * {I}_{i}$$

Step c: summing the weight coefficients of all sampling points to obtain a total weight coefficient.

If the total weight coefficient is represented as w^{A}, then:

$${w}^{A} = {\sum }_{i = 1}^{N} {w}_{i} = {\sum }_{i = 1}^{N} {w}_{0} * {D}^{i - 1}$$

Step d: calculating a ratio of the total color value to the total weight coefficient to obtain a radial blur color value of the first pixel point;

The radial blur color value of the first pixel is represented as I^{B}, then:

$${I}^{B} = \frac{{I}^{A}}{{w}^{A}} = \frac{{\sum }_{i = 1}^{N} {w}_{0} * {D}^{i - 1} * {I}_{i}}{{\sum }_{i = 1}^{N} {w}_{0} * {D}^{i - 1}}$$

S106: assigning the radial blur color value of the first pixel point to the first pixel point.

In some embodiments, each pixel point in the initial image may be traversed, to perform the above steps S103 through S105 to obtain the radial blur color value of each pixel point in the initial image, and then the color value of each pixel point in the initial image is respectively assigned a corresponding radial blur color value to generate a radial blur image corresponding to the initial image.

In other embodiments, the pixel points satisfying the preset condition in the initial image may be traversed, to perform the above step S103 through step S105 to acquire the radial blur color values of the pixel points satisfying the preset condition in the initial image, and then the color values of the pixel points satisfying the preset condition are respectively assigned corresponding radial blur color values to generate a radial blur image corresponding to the initial image.

Exemplarily, the pixels satisfying the preset condition may be pixels of a specified object or pixels within a specified range in the initial image.

According to the image processing method provided by the embodiment of the present disclosure, first, the blur parameter setting interface is displayed, and the weight attenuation coefficient and the radial blur center of the initial image are determined according to the user's operation in the blur parameter setting interface; secondly, radial blur sampling is performed on a first pixel point according to the radial blur center, a color value of at least one sampling point is acquired, and a weight coefficient of each sampling point is obtained according to the initial weight coefficient and the weight attenuation coefficient; then a radial blur color value of the first pixel point is acquired according to the weight coefficient of each sampling point and the color value of each sampling point; then the radial blur color value of the first pixel point is assigned to the first pixel point. The image processing method according to the embodiment of the present disclosure may support the user in setting the weight attenuation coefficient and the radial blur center in the blur parameter setting interface, and may perform the radial blur process on the initial image according to the weight attenuation coefficient and the radial blur center set by the user. Therefore, the embodiment of the present disclosure may extend the adjustability of the radial blur process, thereby satisfying demands of an editing scenario for flexible adjustment of the light- radiating effect. In other words, the embodiments of the present disclosure are used for extending the adjustability of the radial blur process to meet demands of an editing scenario for flexible adjustment of the light-radiating effect.

In some embodiments, the image processing method in the above embodiment further comprises: determining a non-linear adjustment parameter according to the user's operation in the blur parameter setting interface.

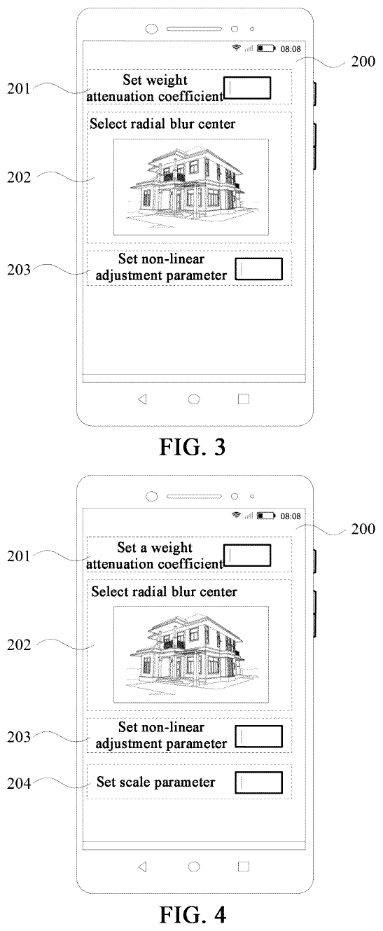

Exemplarily, referring to FIG. 3, the blur parameter setting interface 200 further comprises a third control 203 for setting a non-linear adjustment parameter based on the blur parameter setting interface shown in FIG. 2. The user may operate the third control 203 to set the weight attenuation coefficient.

The above step S105 (acquiring a radial blur color value of the first pixel point according to the weight coefficient of each sampling point and the color value of each sampling point) comprises the following Step 1 through Step 5:
Step 1: respectively calculating a product of the weight coefficient and the color value of each sampling point, and acquiring weight color values of the sampling points.
Step 2: summing the weight color values of all sampling points to obtain a total color value.
Step 3: summing the weight coefficients of all sampling points to obtain a total weight coefficient;
Step 4: calculating a ratio of the total color value to the total weight coefficient to obtain a first color value.

Reference may be made to the implementation of the above Step a through Step d for the implementation of the above Step 1 through Step 4, and the difference only lies in that the calculation result of Step 1 through Step 4 is directly used as the radial blur color value of the first pixel point, whereas the calculation result of Step a through Step d is used as the radial blur color value of the first pixel point after having gone through the processing of a non-linear adjustment parameter.
Step 5: determining a power of the non-linear adjustment parameter of the first color value as the radial blur color value of the first pixel point.

If the radial blur color value of the first pixel point is represented as I^{B}, the first color value is represented as 11, and the non-linear adjustment parameter is represented as gamma, then:

$${I}^{B} = {( {I}^{1} )}^{gamma} = {( \frac{{\sum }_{i = 1}^{N} {w}_{0} * {D}^{i - 1} * {I}_{i}}{{\sum }_{i = 1}^{N} {w}_{0} * {D}^{i - 1}} )}^{g a m m a}$$

In the above-mentioned embodiment, the non-linear adjustment parameter is determined according to the user's operation in the blur parameter setting interface, and the non-linear adjustment is performed on the radial blur color value via the non-linear adjustment parameter. Therefore, the above-mentioned embodiment may make it easier to perform a purposeful adjustment on a partial color range of an image, thereby making the blurring effect of the radial blurring more coordinated.

In some embodiments, the image processing method in the above embodiment further comprises: determining a non-linear adjustment parameter and a scale parameter according to the user's operation in the blur parameter setting interface.

Exemplarily, referring to FIG. 4, based on the blur parameter setting interface of FIG. 2, the blur parameter setting interface 200 further comprises a third control 203 for setting the non-linear adjustment parameter and a fourth control 204 for setting the scale parameter. The user may operate the third control 203 to set the non-linear adjustment parameter and operate the fourth control 204 to set the scale parameter.

The above Step S105 (acquiring a radial blur color value of the first pixel point according to the weight coefficient of each sampling point and the color value of each sampling point) comprises the following Step \textcircled{1} through Step \textcircled{6}
Step \textcircled{1}: respectively calculating a product of the weight coefficient and the color value of each sampling point, and acquiring weight color values of the sampling points.
Step \textcircled{2}: summing the weight color values of all sampling points to obtain a total color value.
Step \textcircled{3}: summing the weight coefficients of all sampling points to obtain a total weight coefficient;
Step \textcircled{4}: calculating a ratio of the total color value to the total weight coefficient to obtain a first color value.
Step \textcircled{5}: calculating a power of the non-linear adjustment parameter of the first color value to obtain a second color value.

Reference may be made to the implementation of the above Step \textcircled{1} through Step \textcircled{5} for the implementation of the above Step \textcircled{1} through Step \textcircled{5}, and the difference only lies in that the calculation result of Step \textcircled{1} through Step \textcircled{5} is directly used as the radial blur color value of the first pixel point, whereas the calculation result of Step \textcircled{1} through Step \textcircled{5} is used as the radial blur color value of the first pixel point after having gone through the processing of the scale parameter.
Step \textcircled{6}: determining a product of the second color value and the scale parameter as a radial blur color value of the first pixel point.

If the radial blur color value of the first pixel point is expressed as I^{B}, the first color value is represented as I¹, the second color value is represented as I², the non-linear adjustment parameter is represented as gamma, and the scale parameter is represented as scale. then:

$${I}^{B} = scale * {I}^{2} = scale * {( {I}^{1} )}^{gamme} = scale * {( \frac{{\sum }_{i = 1}^{N} {w}_{0} * {D}^{i - 1} * {I}_{i}}{{\sum }_{i = 1}^{N} {w}_{0} * {D}^{i - 1}} )}^{g a m m a}$$

In some embodiments, the image processing method in the above embodiment further comprises: determining a non-linear adjustment parameter, a scale parameter and an offset parameter according to the user's operation in the blur parameter setting interface.

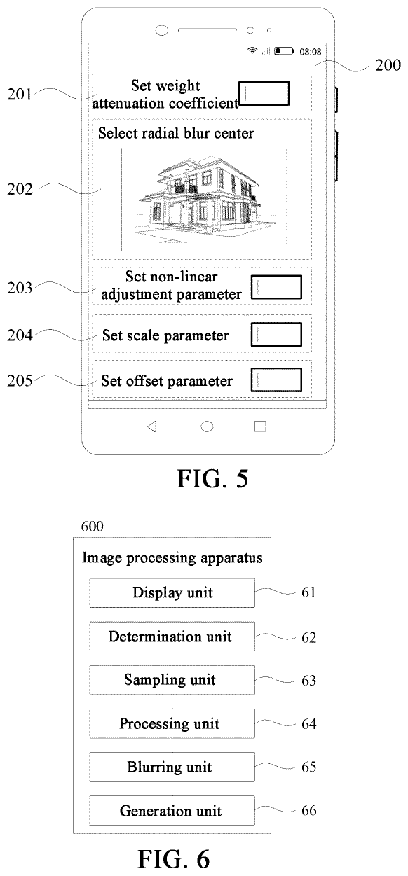

Exemplarily, referring to FIG. 5, based on the blur parameter setting interface of FIG. 2, the blur parameter setting interface 200 further comprises a third control 203 for setting the non-linear adjustment parameter, a fourth control 204 for setting the scale parameter, and a fifth control 205 for setting the offset parameter. The user may operate the third control 203 to set the non-linear adjustment parameter, operates the fourth control 204 to set the scale parameter, and operates the fifth control 205 to set the offset parameter.

The above Step S105 (acquiring a radial blur color value of the first pixel point according to the weight coefficient of each sampling point and the color value of each sampling point) comprises the following Step (1) through Step (7):
Step (1): respectively calculating a product of the weight coefficient and the color value of each sampling point, and acquiring weight color values of the sampling points.
Step (2): summing the weight color values of all sampling points to obtain a total color value.
Step (3): summing the weight coefficients of all sampling points to obtain a total weight coefficient;
Step (4): calculating a ratio of the total color value to the total weight coefficient to obtain a first color value.
Step (5): calculating a power of the non-linear adjustment parameter of the first color value to obtain a second color value.
Step (6): determining a product of the second color value and the scale parameter to obtain a third color value.

Reference may be made to the implementation of the above Step \textcircled{1} through Step \textcircled{6} for the implementation of the above Step \textcircled{1} through Step \textcircled{6}, and the difference only lies in that the calculation result of Step \textcircled{1} through Step \textcircled{6} is directly used as the radial blur color value of the first pixel point, whereas the calculation result of Step \textcircled{1} through Step \textcircled{6} is used as the radial blur color value of the first pixel point after having gone through the processing of the offset parameter.

Step (7): determining a sum of the third color value and the offset parameter as a radial blur color value of the first pixel point.

If the radial blur color value of the first pixel point is represented as I^{B}, the first color value is represented as I¹, the second color value is represented as I², the third color value is represented as I³, the non-linear adjustment parameter is represented as gamma, the scale parameter is represented as scale, and the offset parameter is represented as offset, then:

$${I}^{B} = {I}^{3} + offset = scale * {I}^{2} + offset = scale * {( {I}^{1} )}^{gamma} + offset = scale * {( \frac{{\sum }_{i = 1}^{N} {w}_{0} * {D}^{i - 1} * {I}_{i}}{{\sum }_{i = 1}^{N} {w}_{0} * {D}^{i - 1}} )}^{g a m m a} + offset$$

In some embodiments, the image processing method in the above embodiment further comprises: determining the scale parameter according to the user's operation in the blur parameter setting interface.

The above Step S105 (acquiring a radial blur color value of the first pixel point according to the weight coefficient of each sampling point and the color value of each sampling point) comprises the following Step I, Step II, Step III, Step IV and Step V:

Step I: respectively calculating a product of the weight coefficient and the color value of each sampling point, and acquiring weight color values of the sampling points.

Step II: summing the weight color values of all sampling points to obtain a total color value.

Step III: summing the weight coefficients of all sampling points to obtain a total weight coefficient;

Step IV: calculating a ratio of the total color value to the total weight coefficient to obtain a first color value.

Reference may be made to the implementation of the above Step a through Step d for the implementation of the above Step 1 through Step 4, and the difference only lies in that the calculation result of Step 1 through Step 4 is directly used as the radial blur color value of the first pixel point, whereas the calculation result of Step a through Step d is used as the radial blur color value of the first pixel point after having gone through the processing of the scale parameter.

Step V: determining a product of the first color value and the scale parameter as a radial blur color value of the first pixel point.

If the radial blur color value of the first pixel point is represented as I^{B}, the first color value is represented as I¹, and the scale parameter is represented as scale, then:

$${I}^{B} = scale * {I}^{1} = scale * \frac{{\sum }_{i = 1}^{N} {w}_{0} * {D}^{i - 1} * {I}_{i}}{{\sum }_{i = 1}^{N} {w}_{0} * {D}^{i - 1}}$$

In some embodiments, the image processing method in the above embodiment further comprises: acquiring a radial blur image corresponding to the initial image, at least one pixel point in the radial blur image corresponding to the initial image being assigned a corresponding radial blur color value;
superimposing and fusing the radial blur image corresponding to the initial image and the initial image to acquire a light-radiating effect image corresponding to the initial image.

Exemplarily, the superimposing and fusing the radial blur image corresponding to the initial image and the initial image to acquire a light-radiating effect image corresponding to the initial image may be weighting pixel values of pixel points with the same pixel coordinates in the radial blur image and the initial image according to a preset weight to obtain pixel values of the light-radiating effect image.

Based on the same inventive concept, an embodiment of the present disclosure further provides an image processing apparatus as an implementation of the above method, and the present embodiment corresponds to the above method embodiment; for ease of reading, this embodiment will not repeat the details of the above method embodiment one by one, but it should be appreciated that the image processing apparatus in the present embodiment may correspondingly implement all the content of the above method embodiment.

An embodiment of the present disclosure provides an image processing apparatus. FIG. 6 illustrates a schematic diagram of an image processing apparatus. As shown in FIG. 6, the image processing apparatus 600 comprises:

a display unit 61 for displaying a blur parameter setting interface;

a determination unit 62 for determining a weight attenuation coefficient and a radial blur center of an initial image according to a user's operation in the blur parameter setting interface;

a sampling unit 63 for sampling on a line connecting the radial blur center with a first pixel point of the initial image, and acquiring a color value of at least one sampling point, the first pixel point being any pixel point of the initial image;

a processing unit 64 for acquiring a weight coefficient of each sampling point according to an initial weight coefficient and the weight attenuation coefficient;

a blurring unit 65 for acquiring a radial blur color value of the first pixel point according to the weight coefficient of each sampling point and the color value of each sampling point;

a generation unit 66 for respectively assigning corresponding radial blur color values to color values of pixel points of the initial image to generate a radial blur image corresponding to the initial image.

As an optional embodiment of the embodiment of the present disclosure, the processing unit 64 is specifically used for calculating the weight coefficient of each sampling point by the following equation:

$${w}_{i} = {w}_{0} * {D}^{i - 1}$$

where wᵢ is the weight coefficient of the i^{th} sampling point, w₀ is the initial weight coefficient, and D is the weight attenuation coefficient.

As an optional implementation of an embodiment of the present disclosure, the blurring unit 65 is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a radial blur color value of the first pixel point.

As an optional implementation of an embodiment of the present disclosure, the determination unit 62 is further used for determining a non-linear adjustment parameter according to the user's operation in the blur parameter setting interface;

the blurring unit 65 is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a first color value; determining a power of the non-linear adjustment parameter of the first color value as the radial blur color value of the first pixel point.

As an optional implementation of an embodiment of the present disclosure, the determination unit 62 is further used for determining a non-linear adjustment parameter and a scale parameter according to the user's operation in the blur parameter setting interface;

the blurring unit 65 is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a first color value; calculating a power of the non-linear adjustment parameter of the first color value to obtain a second color value; determining a product of the second color value and the scale parameter as a radial blur color value of the first pixel point.

As an optional implementation of an embodiment of the present disclosure, the determination unit 62 is also used for determining a non-linear adjustment parameter, a scale parameter and an offset parameter according to the user's operation in the blur parameter setting interface;

the blurring unit 65 is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a first color value; calculating a power of the non-linear adjustment parameter of the first color value to obtain a second color value; calculating a product of the second color value and the scale parameter to obtain a third color value; determining a sum of the third color value and the offset parameter as a radial blur color value of the first pixel point.

As an optional implementation of an embodiment of the present disclosure, the determination unit 62 is further used for determining a scale parameter according to the user's operation in the blur parameter setting interface;

the blurring unit 65 is specifically used for respectively calculating a product of the weight coefficient and the color value of each sampling point, and acquiring weight color values of the sampling points; summing the weight color values of all sampling points to obtain a total color value; summing the weight coefficients of all sampling points to obtain a total weight coefficient; calculating a ratio of the total color value to the total weight coefficient to obtain a first color value; determining a product of the first color value and the scale parameter as a radial blur color value of the first pixel point.

As an optional implementation of an embodiment of the present disclosure, the generation unit 66 is also used for acquiring a radial blur image corresponding to the initial image, at least one pixel point in the radial blur image corresponding to the initial image being assigned a corresponding radial blur color value; superimposing and fusing the radial blur image corresponding to the initial image and the initial image to acquire a light-radiating effect image corresponding to the initial image.

The image processing apparatus according to the embodiment of the present disclosure may execute the image processing method according to any of the above embodiments, and the implementation principles and resultant technical effects of the image processing apparatus are similar to those of the image processing method, and will not be described in detail any more herein.

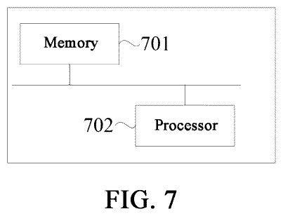

Based on the same inventive concept, an embodiment of the present disclosure further provides an electronic device. FIG. 7 illustrates a schematic diagram of an electronic device according to an embodiment of the present disclosure. As shown in FIG. 7, the electronic device according to the embodiment comprises: a memory 701 and a processor 702, the memory 701 being used for storing a computer program, and the processor 702 being used for performing the image processing method according to the above embodiments upon executing the computer program.

Based on the same inventive concept, an embodiment of the present disclosure further provides a computer-readable storage medium having stored thereon a computer program which, when executed by a processor, causes the computing device to implement the image processing method according to the above embodiments.

Based on the same inventive concept, an embodiment of the present disclosure further provides a computer program product which, when run on a computer, causes the computer to implement the image processing method according to the above embodiments.

As will be appreciated by those skilled in the art, embodiments of the present disclosure may be provided as a method, system, or computer program product. Accordingly, the present disclosure may take the form of an entirely hardware embodiment, an entirely software embodiment or an embodiment combining software and hardware aspects. Moreover, the present disclosure may take the form of a computer program product embodied in one or more computer-usable storage media having computer-usable program code embodied therein.

The processor may be a Central Processing Unit (CPU), and may also be other general-purpose processors, a Digital Signal Processor (DSP), an Application Specific Integrated Circuit (ASIC), a Field-Programmable Gate Array (FPGA) or other programmable logic device, a discrete gate or transistor logic device, discrete hardware components, etc. The general-purpose processor may be a microprocessor, or the processor may also be any conventional processor.

The memory may include forms such as non-persistent memory, Random Access Memory (RAM), and/or non-volatile memory such as Read Only Memory (ROM) or flash memory (flashRAM) in the computer readable medium. The memory is an example of the computer-readable medium.

The computer-readable medium comprises permanent and non-permanent, removable and non-removable storage medium. The storage medium may implement the storage of information by any method or technology, and the information may be computer-readable instructions, data structures, modules of a program, or other data. Examples of the storage medium for a computer includes, but not limited to, Phase Change Random Access Memory (PRAM), Static Random Access Memory (SRAM), Dynamic Random Access Memory (DRAM), other types of random access memory (RAM), Read Only Memory (ROM), Electrically Erasable Programmable Read Only Memory (EEPROM), flash memory or other memory technology, Compact Disk Read Only Memory (CD-ROM), Digital Versatile Disks (DVD) or other optical storage, magnetic cassette-type magnetic tape, magnetic disk storage or other magnetic storage devices, or any other non-transmission media, and may be used to store information accessible by the computing device. As defined herein, the computer-readable medium does not include transitory media, such as modulated data signals and carriers.

Finally, it should be appreciated that the above embodiments are only intended to illustrate the technical solutions of the present disclosure, not to limit them. Although the present disclosure has been described in detail with reference to the above embodiments, those skilled in the art should appreciate that they may still make modifications to the technical solutions disclosed in the above embodiments, or make equivalent substitutions for some or all of the technical features thereof. These modifications or substitutions do not make the essence of corresponding technical solutions depart from the scope of the technical solutions of the embodiments of the present disclosure.

I/we claim:

1. An image processing method, comprising:
displaying a blur parameter setting interface;
determining a weight attenuation coefficient and a radial blur center of an initial image according to a user's operation in the blur parameter setting interface;
performing radial blur sampling on a first pixel point according to the radial blur center, and acquiring a color value of at least one sampling point, the first pixel point being any pixel point of the initial image;
acquiring a weight coefficient of each sampling point according to an initial weight coefficient and the weight attenuation coefficient;
acquiring a radial blur color value of the first pixel point according to the weight coefficient of each sampling point and the color value of each sampling point; and
assigning the radial blur color value of the first pixel point to the first pixel point.

2. The method according to claim 1, wherein acquiring a weight coefficient of each sampling point according to an initial weight coefficient and the weight attenuation coefficient comprises:
calculating the weight coefficient of each sampling point by the following equation:
$${w}_{i} = {w}_{0} * {D}^{i - 1}$$
wherein wᵢ is the weight coefficient of the i^{th} sampling point, w₀ is the initial weight coefficient, and D is the weight attenuation coefficient.

3. The method according to claim 1, wherein acquiring a radial blur color value of the first pixel point according to the weight coefficient of each sampling point and the color value of each sampling point comprises:
calculating a product of the weight coefficient and the color value of each sampling point respectively, and acquiring weight color values of the sampling points;
summing the weight color values of all sampling points to obtain a total color value;
summing the weight coefficients of all sampling points to obtain a total weight coefficient; and
calculating a ratio of the total color value to the total weight coefficient to obtain a radial blur color value of the first pixel point.

4. The method according to claim 1, further comprising:
determining a non-linear adjustment parameter according to the user's operation in the blur parameter setting interface; and
wherein acquiring a radial blur color value of the first pixel point according to the weight coefficient of each sampling point and the color value of each sampling point comprises:
calculating a product of the weight coefficient and the color value of each sampling point respectively, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a first color value; and
determining the first color value to a power of the non-linear adjustment parameter as a radial blur color value of the first pixel point.

5. The method according to claim 1, further comprising:
determining a non-linear adjustment parameter and a scale parameter according to the user's operation in the blur parameter setting interface; and
wherein acquiring a radial blur color value of the first pixel point according to the weight coefficient of each sampling point and the color value of each sampling point comprises:
calculating a product of the weight coefficient and the color value of each sampling point respectively, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a first color value;
calculating the first color value to a power of the non-linear adjustment parameter to obtain a second color value; and
determining a product of the second color value and the scale parameter as a radial blur color value of the first pixel point.

6. The method according to claim 1, further comprising:
determining a non-linear adjustment parameter, a scale parameter and an offset parameter according to the user's operation in the blur parameter setting interface, and
wherein acquiring a radial blur color value of the first pixel point according to the weight coefficient of each sampling point and the color value of each sampling point comprises:
calculating a product of the weight coefficient and the color value of each sampling point respectively, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a first color value;
calculating the first color value to a power of the non-linear adjustment parameter to obtain a second color value;
calculating a product of the second color value and the scale parameter to obtain a third color value; and
determining a sum of the third color value and the offset parameter as a radial blur color value of the first pixel point.

7. The method according to claim 1, further comprising:
determining a scale parameter according to the user's operation in the blur parameter setting interface, and
wherein acquiring a radial blur color value of the first pixel point according to the weight coefficient of each sampling point and the color value of each sampling point comprises:
calculating a product of the weight coefficient and the color value of each sampling point respectively, and acquiring weight color values of the sampling points;
summing the weight color values of all sampling points to obtain a total color value;
summing the weight coefficients of all sampling points to obtain a total weight coefficient;
calculating a ratio of the total color value to the total weight coefficient to obtain a first color value; and
determining a product of the first color value and the scale parameter as a radial blur color value of the first pixel point.

8. The method according to claim 1, further comprising:
acquiring a radial blur image corresponding to the initial image, at least one pixel point in the radial blur image corresponding to the initial image being assigned a corresponding radial blur color value; and
superimposing and fusing the radial blur image corresponding to the initial image and the initial image to acquire a light-radiating effect image corresponding to the initial image.

9. An electronic device, comprising:
one or more processors;
a storage device for storing one or more programs, wherein,
the one or more programs, when executed by the one or more processors, cause the one or more processors to:
display a blur parameter setting interface;
determine a weight attenuation coefficient and a radial blur center of an initial image according to a user's operation in the blur parameter setting interface;
perform radial blur sampling on a first pixel point according to the radial blur center, and acquiring a color value of at least one sampling point, the first pixel point being any pixel point of the initial image;
acquire a weight coefficient of each sampling point according to an initial weight coefficient and the weight attenuation coefficient;
acquire a radial blur color value of the first pixel point according to the weight coefficient of each sampling point and the color value of each sampling point; and
assign the radial blur color value of the first pixel point to the first pixel point.

10. The device according to claim 9, wherein the one or more programs causing the one or more processors to acquire a weight coefficient of each sampling point according to an initial weight coefficient and the weight attenuation coefficient comprise instructions to:
calculate the weight coefficient of each sampling point by the following equation:
$${w}_{i} = {w}_{0} * {D}^{i - 1}$$
wherein wᵢ is the weight coefficient of the i^{th} sampling point, w₀ is the initial weight coefficient, and D is the weight attenuation coefficient.

11. The device according to claim 9, wherein the one or more programs causing the one or more processors to acquire a radial blur color value of the first pixel point according to the weight coefficient of each sampling point and the color value of each sampling point comprise instructions to:
calculate a product of the weight coefficient and the color value of each sampling point respectively, and acquiring weight color values of the sampling points;
sum the weight color values of all sampling points to obtain a total color value;
sum the weight coefficients of all sampling points to obtain a total weight coefficient; and
calculate a ratio of the total color value to the total weight coefficient to obtain a radial blur color value of the first pixel point.

12. The device according to claim 9, the one or more programs further causing the one or more processors to:
determine a non-linear adjustment parameter according to the user's operation in the blur parameter setting interface; and
wherein the one or more programs causing the one or more processors to acquire a radial blur color value of the first pixel point according to the weight coefficient of each sampling point and the color value of each sampling point comprise instructions to:
calculate a product of the weight coefficient and the color value of each sampling point respectively, and acquiring weight color values of the sampling points;
sum the weight color values of all sampling points to obtain a total color value;
sum the weight coefficients of all sampling points to obtain a total weight coefficient;
calculate a ratio of the total color value to the total weight coefficient to obtain a first color value; and
determine the first color value to a power of the non-linear adjustment parameter as a radial blur color value of the first pixel point.

13. The device according to claim 9, the one or more programs further causing the one or more processors to:
determine a non-linear adjustment parameter and a scale parameter according to the user's operation in the blur parameter setting interface; and
wherein the one or more programs causing the one or more processors to acquire a radial blur color value of the first pixel point according to the weight coefficient of each sampling point and the color value of each sampling point comprise instructions to:
calculate a product of the weight coefficient and the color value of each sampling point respectively, and acquiring weight color values of the sampling points;
sum the weight color values of all sampling points to obtain a total color value;
sum the weight coefficients of all sampling points to obtain a total weight coefficient;
calculate a ratio of the total color value to the total weight coefficient to obtain a first color value;
calculate the first color value to a power of the non-linear adjustment parameter to obtain a second color value; and
determine a product of the second color value and the scale parameter as a radial blur color value of the first pixel point.

14. The device according to claim 9, the one or more programs further causing the one or more processors to:
determine a non-linear adjustment parameter, a scale parameter and an offset parameter according to the user's operation in the blur parameter setting interface, and
wherein the one or more programs causing the one or more processors to acquire a radial blur color value of the first pixel point according to the weight coefficient of each sampling point and the color value of each sampling point comprise instructions to:
calculate a product of the weight coefficient and the color value of each sampling point respectively, and acquiring weight color values of the sampling points;
sum the weight color values of all sampling points to obtain a total color value;
sum the weight coefficients of all sampling points to obtain a total weight coefficient;
calculate a ratio of the total color value to the total weight coefficient to obtain a first color value;
calculate the first color value to a power of the non-linear adjustment parameter to obtain a second color value;
calculate a product of the second color value and the scale parameter to obtain a third color value; and
determine a sum of the third color value and the offset parameter as a radial blur color value of the first pixel point.

15. The device according to claim 9, the one or more programs further causing the one or more processors to:
determine a scale parameter according to the user's operation in the blur parameter setting interface, and
wherein the one or more programs causing the one or more processors to acquire a radial blur color value of the first pixel point according to the weight coefficient of each sampling point and the color value of each sampling point comprise instructions to:
calculate a product of the weight coefficient and the color value of each sampling point respectively, and acquiring weight color values of the sampling points;
sum the weight color values of all sampling points to obtain a total color value;
sum the weight coefficients of all sampling points to obtain a total weight coefficient;
calculate a ratio of the total color value to the total weight coefficient to obtain a first color value; and
determine a product of the first color value and the scale parameter as a radial blur color value of the first pixel point.

16. The device according to claim 9, the one or more programs further causing the one or more processors to:
acquire a radial blur image corresponding to the initial image, at least one pixel point in the radial blur image corresponding to the initial image being assigned a corresponding radial blur color value; and
superimpose and fuse the radial blur image corresponding to the initial image and the initial image to acquire a light-radiating effect image corresponding to the initial image.

17. A non-transitory storage medium containing computer-executable instructions which, when executed by a computer processor, the computer-executable instructions cause the computer processor to:
display a blur parameter setting interface;
determine a weight attenuation coefficient and a radial blur center of an initial image according to a user's operation in the blur parameter setting interface;
perform radial blur sampling on a first pixel point according to the radial blur center, and acquiring a color value of at least one sampling point, the first pixel point being any pixel point of the initial image;
acquire a weight coefficient of each sampling point according to an initial weight coefficient and the weight attenuation coefficient;
acquire a radial blur color value of the first pixel point according to the weight coefficient of each sampling point and the color value of each sampling point; and
assign the radial blur color value of the first pixel point to the first pixel point.

18. The storage medium according to claim 17, wherein the computer-executable instructions causing the computer processor to acquire a weight coefficient of each sampling point according to an initial weight coefficient and the weight attenuation coefficient further cause the computer processor to:
calculate the weight coefficient of each sampling point by the following equation:
$${w}_{i} = {w}_{0} * {D}^{i - 1}$$
wherein wᵢ is the weight coefficient of the i^{th} sampling point, w₀ is the initial weight coefficient, and D is the weight attenuation coefficient.

19. The storage medium according to claim 17, wherein the computer-executable instructions causing the computer processor to acquire a radial blur color value of the first pixel point according to the weight coefficient of each sampling point and the color value of each sampling point further cause the computer processor to:
calculate a product of the weight coefficient and the color value of each sampling point respectively, and acquiring weight color values of the sampling points;
sum the weight color values of all sampling points to obtain a total color value;
sum the weight coefficients of all sampling points to obtain a total weight coefficient; and
calculate a ratio of the total color value to the total weight coefficient to obtain a radial blur color value of the first pixel point.

20. The storage medium according to claim 17, the computer-executable instructions further causing the processor to:
determine a non-linear adjustment parameter according to the user's operation in the blur parameter setting interface; and
wherein the computer-executable instructions causing the computer processor to acquire a radial blur color value of the first pixel point according to the weight coefficient of each sampling point and the color value of each sampling point further cause the computer processor to:
calculate a product of the weight coefficient and the color value of each sampling point respectively, and acquiring weight color values of the sampling points;
sum the weight color values of all sampling points to obtain a total color value;
sum the weight coefficients of all sampling points to obtain a total weight coefficient;
calculate a ratio of the total color value to the total weight coefficient to obtain a first color value; and
determine the first color value to a power of the non-linear adjustment parameter as a radial blur color value of the first pixel point.
